(19) United States
(12) Patent Application Publication
(10) Pub. No.: US 2001/0003187 A1
(43) Pub. Date: Jun. 7, 2001

(54) Task parallel processing method

(76) Inventors: Yuichiro Aoki, Yokohama (JP); Makoto Sato, Machida (JP)

Correspondence Address: Mattingly, Stanger & Malur, P.C., 104 East Hume Avenue, Alexandria, VA, 22301, US

(21) Appl. No.: 09/729,975

(22) Filed: Dec. 6, 2000

(30) Foreign Application Priority Data
Dec. 7, 1999 (JP) 11-347090

(51) Int. Cl. G06F 9/00

(52) U.S. Cl. 709/102; 709/104

(57) ABSTRACT

The task parallelization method is realized by: detecting both data which may be probably referred to a relevant task capable of satisfying a predetermined condition and also an instruction code contained in the task when being compiled; producing an information transfer task which is constructed of such an instruction for instructing that both the data and the instruction code are transferred to a storage apparatus closer to a processor to which the task is allocated; and adding to the process, a task scheduling process constituted by allocation instructions by which a next-execution task is acquired and the information transfer task with respect to the next-execution task is executed by an idle processor.

### BACKGROUND OF THE INVENTION

The present invention relates to a task parallel processing technique of a parallelizing compiler in which a source program is subdivided into tasks and these tasks are compiled/converted into programs, or object codes executable in a multiprocessor. More specifically, the present invention is directed to a task parallelization (parallel processing) method suitably capable of outputting either programs or object codes, executable at a high speed.

Conventionally, a task parallelization executed in a parallelizing compiler is arranged by the following three steps, as described in, for example, K. AIDA et. al., “Performance Evaluation of Fortran Coarse Grain Parallel Processing on Shared Memory Multiprocessor Systems”, IPSJ (Information Processing Society of Japan) Journal, March, 1996, vol. 37, No. 3, pp. 418 to 429 (referred to as a “publication 1” hereinafter):

(1) A program is subdivided into small portions called as tasks.

(2) An “executable condition” of each of these tasks is conducted from a relationship between control flows and reference orders of variables among the tasks.

(3) Either a program or an object code, which is constituted a task and “task scheduling processing” containing an executable condition inserted into a head of a task.

In this connection, an “executable condition” implies such a condition indicative of an execution order relationship among tasks, and thus, implies such a fact that a task capable of satisfying this executable condition may be commenced to be executed. Also, “task scheduling processing” implies such a process operation that while monitoring as to whether or not an idle processor which does not execute a task is present and also as to whether or not an executable condition of a task can be established, such a task capable of the executable condition is allocated to an idle processor so as to be executed.

Now, the below-mentioned program will be considered. It should be understood that reference numerals shown in left ends are line numbers of this program:

1: #define N 1000

2: int a[N], b[N], c[N], i, j, k;

3: main( ){

4: for(i=0;i<N;i++) {/*task 1*/

5: a[i]=i * 2;

6: }

7: for(j=1;j<N;j++) {/*task 2*/

8: if(j==1) {b[0]=0;}

9: b[j]=a[j]+b[j−1];

10: if(j==N−1) {printf(“b[N−1]=%d¥n”, b[j]);}

11: }

12: for(k=1;k<N;k++) {/*task 3*/

13: if(K==1) {c[0]=0;}

14: c[k]=a[k]+c[k−1];

15: }

16:}

There are three loops in this program example. When each of these three loops is used as a single task and these loops are task-parallelized, a fourth line to a sixth line of this program constitute a “task 1”, a seventh line to an 11-th line thereof constitute a “task 2”, and a 12-th line to a 15-th line thereof constitute a “task 3”. When variables referred over the tasks are investigated by considering control flows among the tasks, since an array “a” defined in the task 1 is used in both the task 2 and the task 3, the following fact can be revealed: That is, both the task 2 and the task 3 are not executed unless the execution of the task 1 has been completed. In this case, a definition implies that a value is substituted for a variable, and a use implies that a value of a variable is employed.

As apparent from the foregoing description, the executable conditions of the respective tasks are given as follows: As to the task 1, the executable condition becomes no limitation condition (namely, task is always executable), whereas as to the task 2 and the task 3, the executable conditions thereof are given by the end of the task 1.

FIG. 15 is a task execution graph for representing execution conditions of the respective tasks in such a case that this task parallelization program is executed in a parallel mode by employing two sets of processors.

Also, FIG. 15 shows an example of the task execution graph representative of a task execution condition. In the task execution graph 15001, an abscissa shows time measured from a commencement of a program execution, an ordinate represents a processor number, and a rectangle contained in this task execution graph indicates a section where each of the tasks is executed.

As apparent from the above-explained executable condition and the task execution graph of FIG. 15, since there is no such a task which can be executed at the same time in connection with the task 1, a processor (1) may constitute an idle processor while another processor (0) executes the task 1. In other words, in the conventional technique, such an idle processor cannot be effectively utilized. This idle processor is produced in the case that at a certain time instant while the program is executed, a total number of executable tasks is smaller than a total number of usable processors.

### SUMMARY OF THE INVENTION

The present invention has been made to solve the above-described conventional problems, and therefore, has an object to provide a task parallelization method, a task parallelization apparatus, and also a computer readable storage medium for storing thereinto a program used to execute the task parallelization method capable of outputting a program, or an object code, whose execution time is shortened, while an idle processor is effectively used.

To achieve the above-described object, a task parallelization method of the present invention is directed to such a task parallelization method used in a parallelizing compiler for converting a source program into one of a program and an object code, which is arranged by a plurality of tasks executable by a multiprocessor and by a task scheduling process used to allocate the plural tasks to processors. In the task parallelization method according to the present invention, the below-mentioned steps are executed:

(a). As to a task capable of satisfying a preselected condition, both data which may be probably referred to this task and also an instruction code contained in the task are detected when being compiled.

(b). An information transfer task is produced which is constructed of such an instruction for instructing that both the detected data and the detected instruction code are transferred to another storage apparatus closer to a processor to which this task is allocated if a data transfer path from this storage apparatus into which these data and instruction code are stored to the processor is not the closest one. Otherwise, no data/instruction code is transferred if the data transfer path is the closest data transfer path of the storage apparatus, as viewed from the processor to which this task is allocated by the task scheduling process.

(c). While monitoring as to whether there is such an idle processor which does not execute a task, if such an idle processor is found out, then end time instants of tasks which are executed by processors other than this idle processor are predicted. Furthermore, a next-execution task is determined based on the task whose predicted end time instant is the earliest one. This next-execution task corresponds to such a task which will be allocated in next time to the idle processor. An information transfer task scheduling process is added to a task scheduling process. This information transfer scheduling process is constituted by such instructions by which an information transfer task with respect to the determined next-execution task is executed in the idle processor.

### BRIEF DESCRIPTION OF THE DRAWINGS

For a better understanding of the present invention, reference is made of a detailed description to be read in conjunction with the accompanying drawings, in which:

FIG. 1 is a flow chart for explaining an example of process operation of a task parallelization method according to the present invention;

FIG. 2A illustratively represents an execution condition of tasks in the case that the task parallelization method of the present invention is applied;

FIG. 2B illustratively shows an execution condition of tasks in the case that the conventional task parallelization method is applied;

FIG. 3 schematically indicates a structural example of a parallelizing compiler for executing the task parallelization method according to the present invention;

FIG. 4 illustratively shows a hardware construction of a system for executing the parallelizing compiler shown in FIG. 3;

FIG. 5 illustratively indicates a structural example of a multiprocessor system employing the task parallelizing compiler shown in FIG. 3;

FIG. 6 represents an example of an input program used in the multiprocessor system of FIG. 3;

FIG. 7 represents a front half portion of an example of an output program in the task parallelization method process operation of FIG. 3;

FIG. 8 represents a rear half portion of the example of the output program in the task parallelization method process operation of FIG. 3;

FIG. 9 shows a structural example of a table for collecting executable conditions which are analyzed from the input program of FIG. 6 by a task analyzing unit 25 shown in FIG. 3;

FIG. 10 is a flow chart for describing a process sequential example of a transfer information detecting unit shown in FIG. 3;

FIG. 11 shows a structural example of an array reference region table and also a task table, which are acquired by the process sequential operation of the transfer information detecting unit shown in FIG. 10;

FIG. 12 is a flow chart for describing a process sequential example of a task scheduling processing expansion unit shown in FIG. 3;

FIG. 13 is a flow chart for describing a process sequential example of an information transfer task generating unit shown in FIG. 3;

FIG. 14 is a flow chart for explaining a process sequential example of a next-execution task acquisition function; and

FIG. 15 shows an example of a task execution graph indicative of a task execution condition.

### DESCRIPTION OF THE EMBODIMENTS

Referring now to drawings, embodiment modes of the present invention will be described in detail.

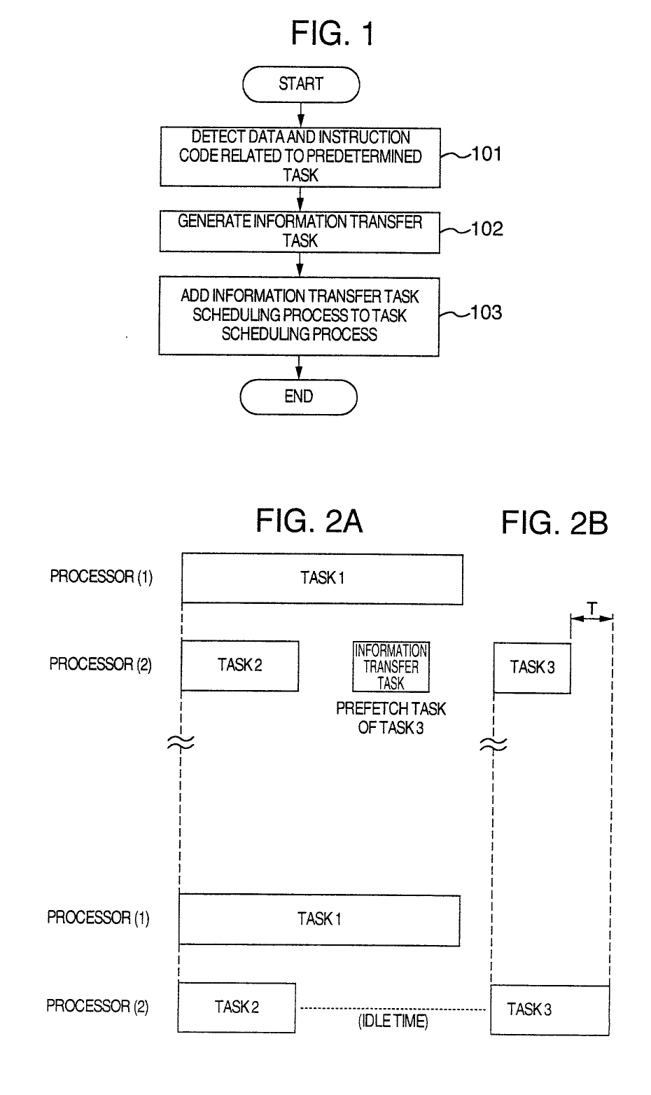

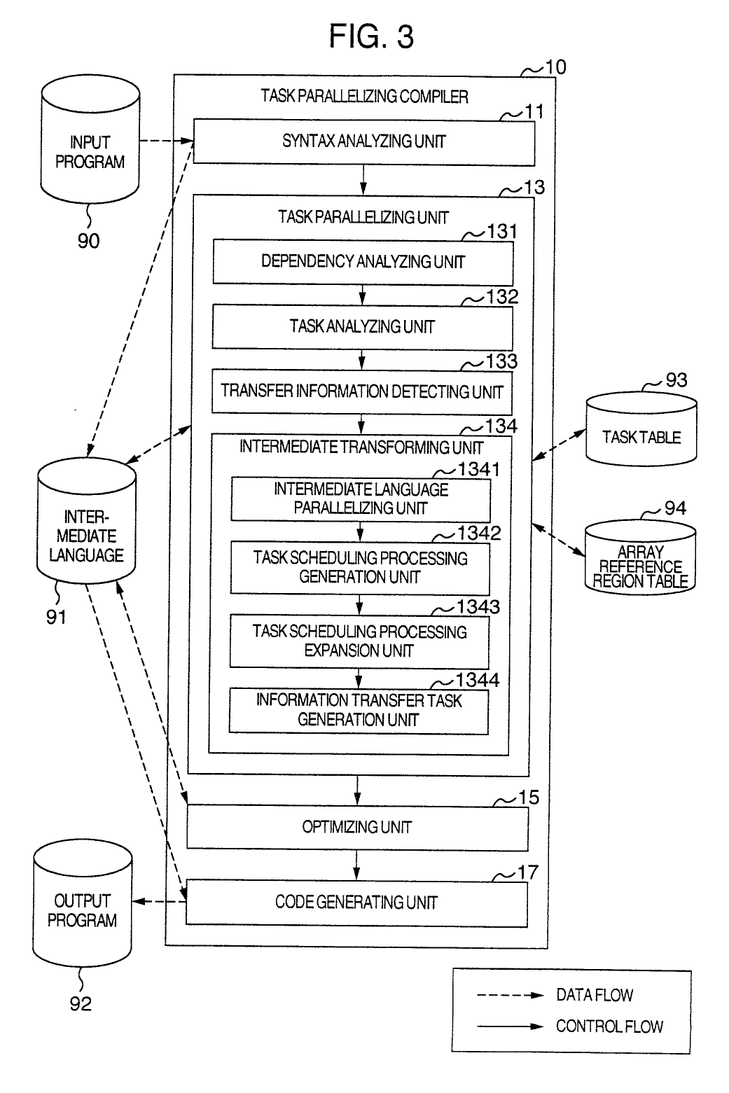

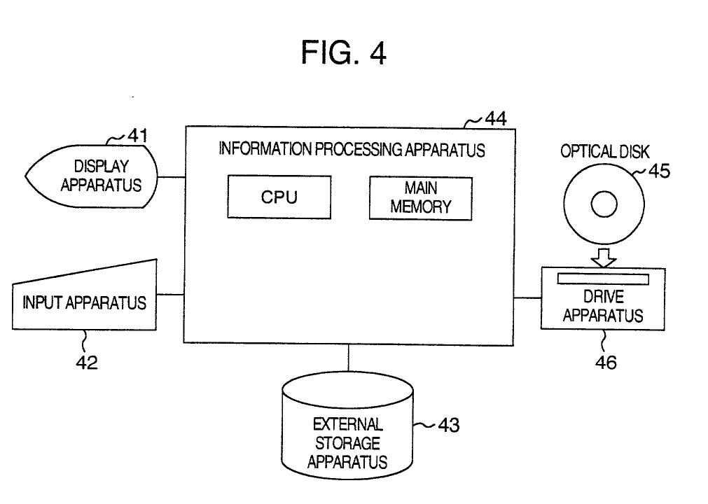

FIG. 1 is a flow chart for describing an example of a process operation executed by a task parallelization method according to the present invention. FIG. 2A is an explanatory diagram for representing a summarized example of task execution conditions by the task parallelization method shown in FIG. 1. FIG. 3 is a block diagram for schematically indicating a structural example of a parallelizing compiler for executing the task parallelization method according to the present invention. FIG. 4 is a block diagram for illustratively showing a hardware construction of a system for executing the parallelizing compiler shown in FIG. 3.

First, a description will now be made of a process operation of the task parallelization method according to the present invention with reference to FIG. 2. In FIG. 2A illustratively indicates an example of execution conditions of tasks 1 to 3 in accordance with the task parallelization method of the present invention, and FIG. 2B illustratively shows execution conditions of the tasks 1 to 3 according to the conventional method. It should be noted that both the task 1 and the task 2 can be executed at the same time, whereas the task 3 cannot be executed unless the executions of both the task 1 and the task 2 have been accomplished.

In other words, as shown in FIG. 2B, in the conventional task parallelization method, a processor (2) which has accomplished the execution of the task 2 commences the execution of the task 3 after the execution of the task 1 by another processor (1) has been accomplished. It is now assumed that this execution of the task 3 involves such a process operation that both data referred to the task 3 and an instruction code contained in the task 3 are transferred from a shared memory to, for example, a cache memory.

Thus, in accordance with the task parallelization method of this example, as shown in FIG. 2A, a processor (2) which has accomplished the execution of the task 2 transfers both the data referred to the task 3 and the instruction code contained in the task 3 to the cache while the task 1 is executed by another processor (1) (prefetch task). Then, after the execution of the task 1 by the processor (1) has been accomplished, the processor (2) accesses the cache to start the execution of the task 3. As a result, the execution completion time of the task 3 may be shortened by T time (namely saved by the prefetch task), as compared with that of the conventional method.

Subsequently, a process operation of the parallelizing compiler related to such a task parallelization will now be explained with reference to FIG. 1. The parallelizing compiler of this example to which a source program is inputted outputs either a program or an object code, which is constituted by plural executable tasks and also a task scheduling process for a multiprocessor. The task scheduling process allocates tasks to the processors.

As the parallelization method of the task, first, when compiling operation is performed, with respect to such a task capable of satisfying a predetermined condition (executable condition) in order to commence the execution, either data which may be probably referred within this task or an instruction code contained in this task is detected (step 101).

Next, a check is made as to whether or not a storage apparatus in which either the detected data or the detected instruction code is stored corresponds to such a storage apparatus whose data transfer path is the closest path, as viewed from the processor to which this task is allocated by the above-described task scheduling process. When the storage apparatus corresponds to the storage apparatus whose data transfer path is the closest path, no process operation is performed. If not, then an information transfer task constituted by instructions capable of transferring this task to closer storage apparatus is produced (step 102).

Finally, a monitoring operation is carried out as to whether or not there is such an idle processor which does not execute a task. When the idle processor is found out, an end time instant of a task which is executed a processor other than this idle processor is predicted. A next-execution task which will be subsequently allocated to the idle processor is determined based on such a task, the predicted end time instant of which is the earliest. In order that an information transfer task with respect to the determined next-execution task is executed by the idle processor, an information transfer task scheduling process is added to a task scheduling process (step 103). This information transfer task scheduling process is constituted by instructions for allocating the processors. The task scheduling processing operation allocates the next-execution task to the idle processor.

With execution of the above-explained process operation, as indicated in FIG. 2A, the information transfer task scheduling process is added to the task scheduling process of the processor (2) functioning as such an idle processor by which the execution of the task 2 is accomplished. As a result, in the processor (2), while the task 1 is executed by the processor (1), both the data referred to the task 3 and the instruction code contained in the task 3 can be transferred to the cache (predetch task).

Next, referring to FIG. 4, a description will now be made of a hardware structure of a system for executing a parallelizing compiler which executes such a task parallelization.

As illustrated in FIG. 4, the parallelizing compiler of the present invention is implemented by such a computer system arranged by a display apparatus 41, an input apparatus 42, an external storage apparatus 43, a processing apparatus 44, an optical disk 45, and a disk driving apparatus 46. The display apparatus 41 is made of a CRT (Cathode-Ray Tube) and the like, and displays a character and an image. The input apparatus 42 is constructed of a keyboard, a mouse, and the like, and inputs an instruction issued from an operator. The external storage apparatus 43 is constituted by an HDD (Hard Disk Drive) and the like, and stores thereinto data having a large storage capacity and programs having large storage capacities. The processing apparatus 44 contains a CPU (Central Processing Unit) and a main memory, and executes a calculation process operation by way of a stored program method. The optical disk 45 may function as a recording medium which records thereon a program and also data related to the processing sequential operation of the present invention. The disk driving apparatus 46 reads out the data and the program which have been stored in the optical disk 45 and will be stored in the external storage apparatus 43 in response to an instruction issued from the processing apparatus 44.

The processing apparatus 44 constitutes a task parallelizing compiler made of the respective structural elements shown in FIG. 3 by loading both the data and the program read from the optical disk 45, which have been stored in the external storage apparatus 43.

Subsequently, the task parallelizing compiler 10 will now be described with reference to FIG. 3.

As indicated in FIG. 3, the task parallelizing compiler 10 is arranged by a syntax analyzing unit 11, a task parallelizing unit 13, an optimizing unit 15, and a code generating unit 17. This task parallelizing compiler 10 compiles an input program 90 to generate an output program 92. Next, the respective structural units will now be explained.

The syntax analyzing unit 11 enters thereinto the input program 90 to output an intermediate language 91. It should also be noted that the processing operation by the syntax analyzing unit 11 is the same as that of the normal compiler.

The task parallelizing unit 13 enters thereto the intermediate language 91 to output the task-parallelized intermediate language 91. The task parallelizing unit 13 is arranged by a dependence analyzing unit 131, a task analyzing unit 132, a transfer information detecting unit 133, and an intermediate language transforming unit 134.

The dependency analyzing unit 131 enters thereinto the intermediate language 91 so as to analyze a data dependency relationship. It should also be noted that the processing operation of this dependency analyzing unit 131 is the same as to that of the normal compiler.

The task analyzing unit 132 enters thereinto the intermediate language 91 so as to execute a task parallelism analysis. The processing operation of this task analyzing unit 132 is identical to the method which is described in H. Honda, M. Iwata, and H. Kasahara, “Coarse Grain Parallelism Detection Scheme of a Fortran Program Method”, The Transactions of the Institute of Electronics, Information and Communication Engineers, D-I, December, 1990, vol. J73-D-I, No. 12, pp. 951 to 960 (referred to as a “Publication 2” hereinafter).

As previously described, the transfer information detecting unit 133 inputs thereinto the intermediate language 91, and analyzes such information required to generate an “information transfer task” by detecting either data or an instruction code with respect to a task capable of satisfying an executable condition. This data owns a possibility to be referred within this task. This instruction code is contained in this task. Then, the transfer information detecting unit 133 outputs an analysis result to both a task table 93 and an array reference region table 94.

The intermediate language transforming unit 134 enters thereinto the intermediate language 91, the task table 93 and the array reference region table 94 to thereby output such a task-parallelized intermediate language 91 which contains both “information transfer task” and “information transfer task scheduling process”. This intermediate language transforming unit 134 is arranged by an intermediate language parallelizing unit 1341, a task scheduling process generating unit 1342, a task scheduling process expanding unit 1343, and an information transfer task generating unit 1344, which will be described later.

The intermediate language transforming unit 1341 inputs the intermediate language 91 to thereby output the task-parallelized intermediate language 91. The task scheduling process generating unit 1342 enters thereinto the intermediate language 91 which is outputted from the intermediate transforming unit 1341, and then outputs the task-parallelized intermediate language 91 containing the task scheduling processing operation. The task scheduling process expanding unit 1343 inputs thereinto the intermediate language 91 which is outputted by the task scheduling process generating unit 1342, and then outputs such a task-parallelized intermediate language 91 which contains the task scheduling process to which “information transfer task scheduling process” is added. The information transfer task generating unit 1344 inputs thereinto the intermediate language 91 which is outputted by the task scheduling process expanding unit 1343, and then, outputs such a task-parallelized intermediate language 91 containing the task scheduling process to which both the information transfer task and the information transfer task scheduling process are added.

The above-explained processing operations of both the transfer information detecting unit 133 and the intermediate language transforming unit 134 may constitute featured processing units of the present invention.

The optimizing unit 15 inputs thereinto the intermediate language 91 which is task-parallelized by the task parallelizing unit 13 to thereby output the optimized intermediate language 91. The code generating unit 17 enters thereinto such an intermediate language 91 optimized by the optimizing unit 15 to thereby output either the task-parallelized program or the object code. It should also be noted that the processing operations of these optimizing unit 15 and code generating unit 17 are the same as those of the normal compiler.

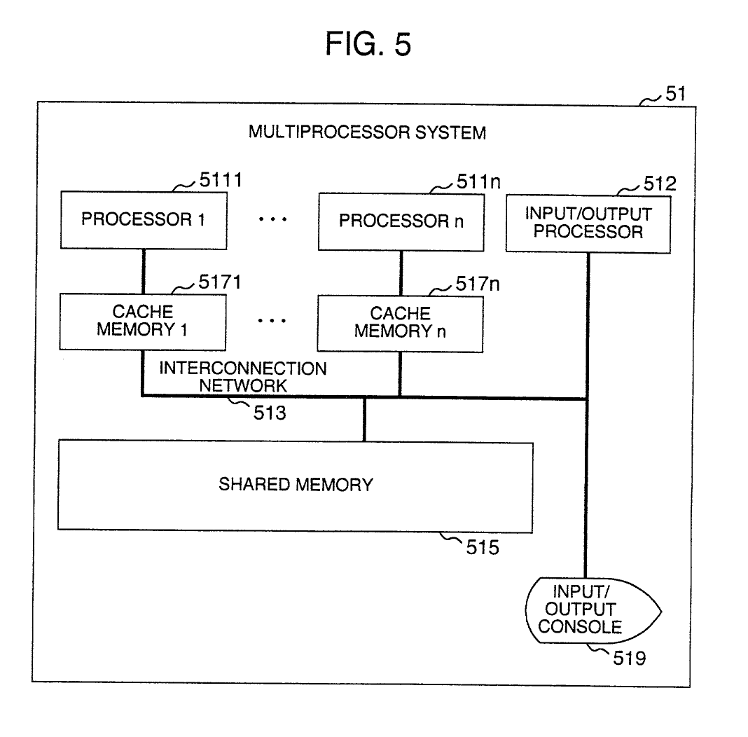

Subsequently, an example of a task parallelizing operation executed by the task parallelizing compiler 10 with employment of such an arrangement will now be described with reference to FIG. 5.

FIG. 5 is a block diagram for showing a structural example of a multiprocessor system capable of implementing the task parallelizing compiler shown in FIG. 3. The multiprocessor system 51 shown in FIG. 5 is arranged by processors 5111 to 511n, cache memories 5171 to 517n, a shared memory 515, an input/output (I/O) processor 512, an input/output (I/O) console 519, and also an interconnection network 513. In the multiprocessor indicated in FIG. 5, in such a case that data under access operation is prefetched to the cache memory, since an invalid flag is set to this data, the latest data is set to the cache memory when this data is used. As a result, as explained in the task parallelization method according to the present invention, the data which is accessed by the task under execution can be prefetched in order to execute the next-execution task.

The task parallelizing compiler 10 shown in FIG. 3 is executed in the I/O console 519, and the input program 90 of FIG. 3 is transformed into a parallel source program. Furthermore, this transformed parallel source program is further transformed into a parallel object program by a compiler directed to the processor 5111 to 511n.

Then, this parallel object program is transformed by a linker into a load module, and the load module is loaded to the shared memory 515 via the I/O processor 512, which is executed by the respective processors 5111 to 511n. At this time, in the load module loaded in the shared memory 515, the information transfer task previously executes an access to the shared memory 515 corresponding to such a storage apparatus including an array to be referred to in the next-execution task by the idle processor.

As a result, when the execution of the next-execution task is commenced, the array to be referred to this next-execution task is present in the cache memories 5171 to 517n which are the storage apparatus closer to the processors 5111 to 511n rather than the shared memory 515. As a result, since the execution time of the next-execution task is shortened, the program execution time can be shortened.

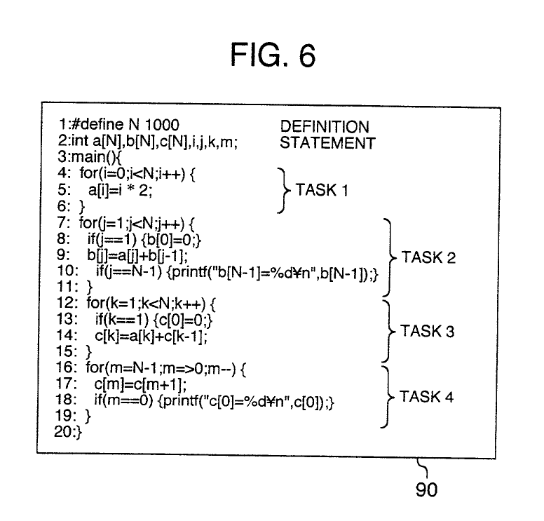

Next, a concrete operation example of the task parallelizing compiler 10 having the arrangement shown in FIG. 3 will now be explained with reference to an example of the input program 90 indicated in FIG. 6. It should be understood that reference numerals appeared at the left end of the input program 90 shown in FIG. 6 denote line numbers.

That is, a first line corresponds to such a statement that a value of a constant N is equal to 1000; and a second line corresponds to a declarative statement of an interger type one-dimensional array “a”, “b”, “c” in which a primary line owns an index range “0” to “N−1”, and also interger variables “i”, “j”, “k”, “m”. A third line through a 20-th line correspond to a main function “main” of the input program 90. A fourth line to a sixth line correspond to such a loop where “i” is used as a loop control variable. Subsequently, the loop is expressed by employing a line number of a head line. In other words, this loop is expressed as a loop 4. A seventh line through an 11-th line correspond to a loop 7 in which “j” is used as a loop control variable. A 12-th line through a 15-th line correspond to a loop 12 in which “k” is used as a loop control variable. A 16-th line to a 19-th line correspond to a loop 16 in which “m” is used as a loop control variable.

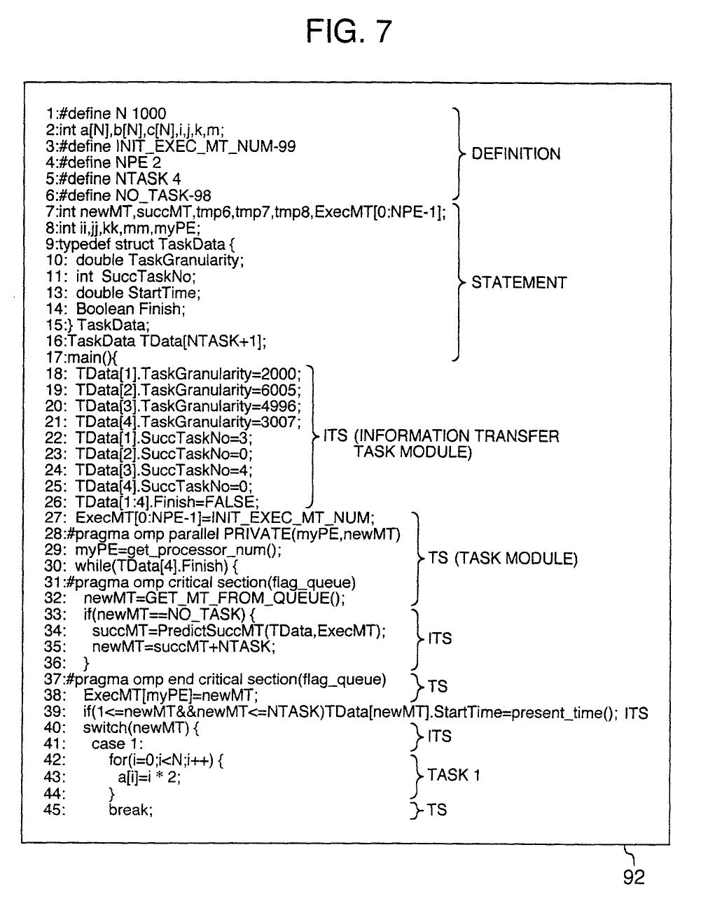

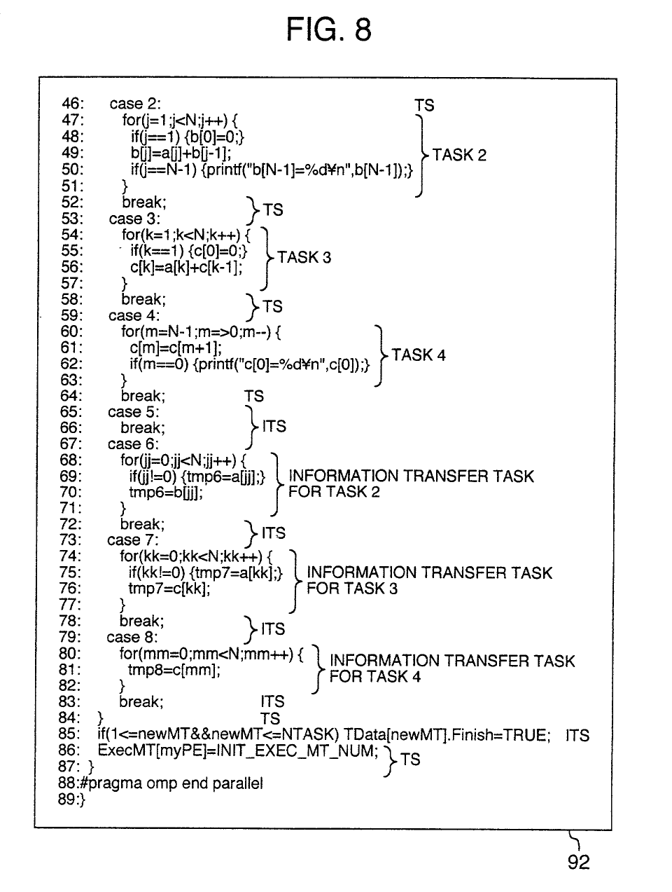

FIG. 7 and FIG. 8 are explanatory diagrams for explaining an example of the output program shown in FIG. 1. It should also be noted that reference numerals appeared at left ends of FIG. 7 and FIG. 8 denote line numbers.

That is, a first line corresponds to such a statement that a value of a constant N is equal to 1000; and a second line corresponds to a declarative statement of an integer type one-dimensional array “a”, “b”, “c” in which a primary line owns an index range “0” to “N−1”, and also integer variables “i”, “j”, “k”, “m”. A third line to a sixth line correspond to such a statement that values of constants INIT_EXEC_MT_NUM, NPE, NTASK, and NO_TASK are defined as “−99”, “2”, “4”, and “−98”.

A seventh line corresponds to a declarative statement of an integer type one-dimensional array ExecMT having an index range of 0 to NPE−1, and also having integer variables newMT, succMT, tmp5, tmp6, tmp7, and tmp8. An eighth line corresponds to a declarative statement of integer variables ii, kk, kk, mm, myPE. A ninth line to a 15-th line correspond to a declarative statement of a structure TaskData having an elements, a double precision variable TaskGranularity, another double precision variable SuccTaskNo, another double precision variable StartTime, and a Boolean variable Finish. A 16-th line corresponds to a declarative statement of an array TData having an index range of “0” to “NTASK”, in which the structure TaskData is used as an element.

A 17-th line through an 89-th line correspond to a main function “main” of the output program 92. Among these lines, a 27-th line to a 32-th line; a 37-th line to a 38-th line; a 40-th line to a 41st line; a 45-th line to a 46-th line; a 52nd line to a 53rd line; a 58-th line to a 59-th line; a 64-th line, an 84-th line; and an 86-th line to an 87-th line correspond to a program portion capable of executing the task scheduling processing operation.

A 42nd line to a 44-th line correspond to a task 1; a 47-th line to a 51st line correspond to a task 2; a 54-th to a 57-th correspond to a task 3; and a 60-th line to a 63rd line correspond to a task 4. Also, an 18-th line to a 26-th line; a 33rd line to a 36-th line; a 39-th line; a 65-th line to a 67-th line; a 72nd line to a 73rd line; a 78-th line to a 79-th line; an 83rd line; and also an 85th line correspond to a program portion capable of executing the information transfer task scheduling processing operation. A 68-th line to a 71st line correspond to an information transfer task with respect to the task 2; a 74-th line to a 77-th line correspond to an information transfer task with respect to the task 3; and also an 80-th line to an 82-th line correspond to an information transfer task with respect to the task 4.

Subsequently, a description will now be made of each process operation executed in the task paralleling compiler 10 of FIG. 3 related to both the input program 90 shown in FIG. 6 and the output program 92 shown in FIG. 7 and FIG. 8.

First, the syntax analyzing unit 11 inputs thereinto the input program 90 to thereby output the intermediate language 91. It should also be noted that since the intermediate language 91 corresponds to the input program 90 of FIG. 6, this input program 90 of FIG. 6 will be employed as a representation of a source program image of the intermediate language.

Next, the task parallelizing unit 13 executes the following process operations by way of the dependency analyzing unit 131, the task analyzing unit 132, the transfer information detecting unit 133, and the intermediate language transforming unit 134.

In the dependency analyzing unit 131, the intermediate language 91 is inputted so as to analyze a data dependency relationship by executing such a process operation as explained in Alfred V. Aho, Ravi Sethi, and Jeffrey D. Ullman, “Compilers”, Addison-Wesley Publishing Company, 1986.

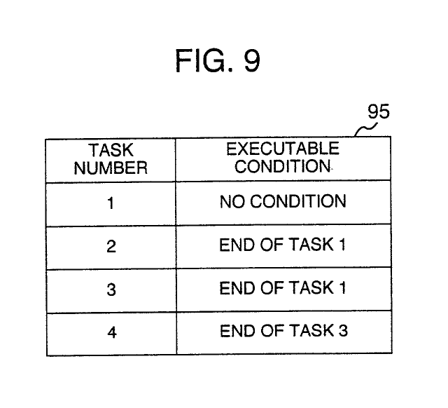

The task analyzing unit 132 enters the intermediate language 91 so as to execute a task parallelism analysis. In the input program 90 of FIG. 6, the loop 4 is analyzed as the task 1, the loop 7 is analyzed as the task 2, the loop 12 is analyzed as the task 3, and the loop 16 is analyzed as the task 4. Also, the executable conditions of the tasks 1 to 4 are analyzed as “task 1: no limitation condition”, “task 2=end of task 1”, “task 3=end of task 1”, and “task 4=end of task 3”, respectively. These executable conditions are collected as a table 95 shown in FIG. 9 and are stored. FIG. 9 schematically represents a structural example of the table 95 which collects the executable conditions analyzed from the input program of FIG. 6 by the task analyzing unit of FIG. 3. In the table 95 of the executable condition in this example, the executable conditions of the respective tasks 1 to 4 are collected to be registered as follows: “task 1: no limitation condition”, “task 2=end of task 1”, “task 3=end of task 1”, and “task 4=end of task 3”, respectively.

Furthermore, the task analyzing unit 132 obtains a “program ending task” by performing the below-mentioned general-purpose technical idea. This “program ending task” is such an only one task capable of assuming an end of an execution of this task as an end of the program. In other words, while a “task graph” is formed in which the tasks correspond to nodes, and a control dependency relationship among these tasks corresponds to an edge, such a “program ending task” equal to a dummy task containing no process operation is added to this “task graph”. Then, since an edge defined from a task having no starting point of the edge to the “program ending task”, the dummy task is recognized as the “program ending task”. It should be noted that when there is only one edge in which the “program ending task” is used as an ending point, since the task corresponding to the starting point of this edge can be regarded as the “program ending task”, the task 4 may be set as the program ending task in the input program of FIG. 6.

A detailed process operation of such a task analyzing unit 132 is described in the technique described in the above-explained publication 2.

Next, the transfer information detecting unit 133 inputs the intermediate language 91 so as to analyze an array reference region referred within each of the tasks 1 to 4, and then outputs this analysis result to an array reference region table 94, whereas the transfer information detecting unit 133 estimates task execution time and also analyzes a total number of tasks capable of satisfying the executable condition when this task is firstly ended. Then, the transfer information detecting unit 133 outputs these estimation/analysis results to the task table 93. In this case, a reference implies that a variable is defined, or used; a variable implies either a scalar variable or an array; a definition implies that a value is substituted for a variable; a use implies that a value of a variable is employed; and a reference range of an array implies an index range in which an array thereof may be probably referred.

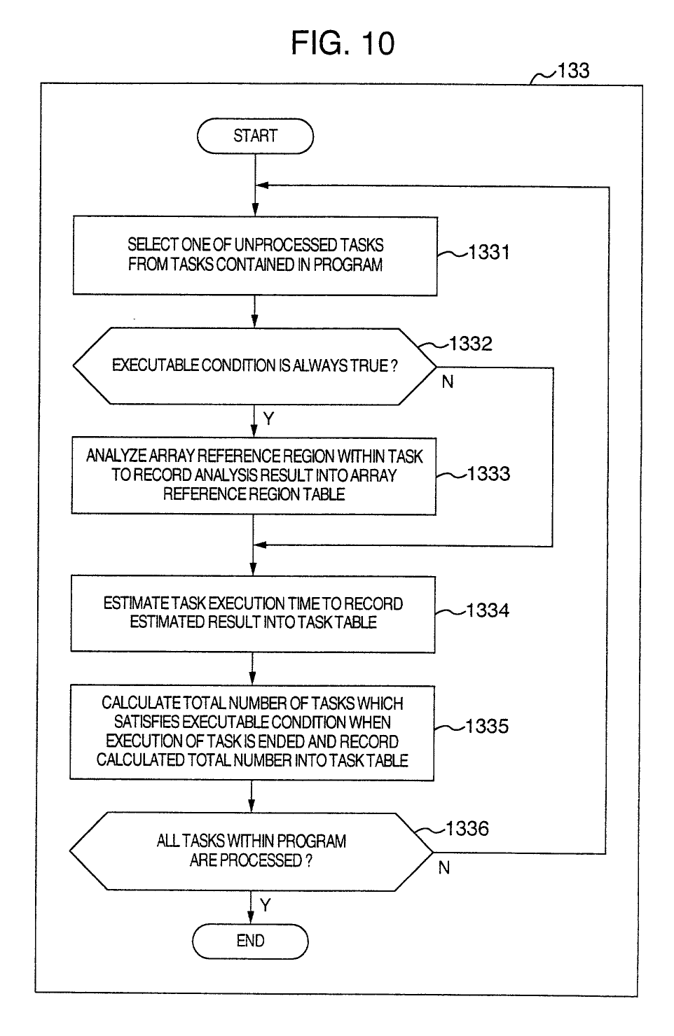

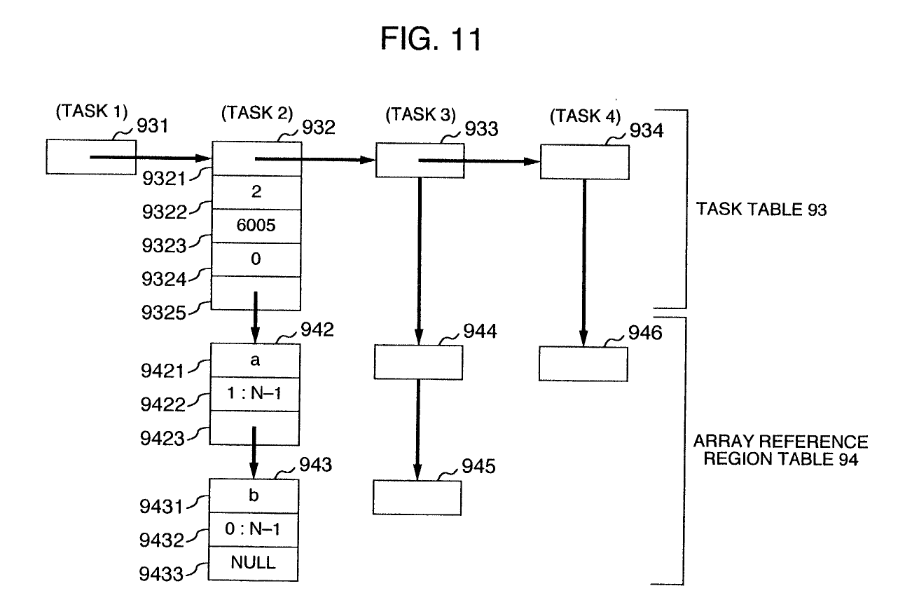

The processing operation of the transfer information detecting unit 133 will now be explained with reference to FIG. 10 and FIG. 11.

FIG. 10 is a flow chart for describing a process sequential example of a transfer information detecting unit shown in FIG. 3. FIG. 11 shows a structural example of an array reference region table and also a task table 93, which are acquired by the process sequential operation of the transfer information detecting unit shown in FIG. 10.

Since the transfer information detecting unit 133 of FIG. 3 executes process operations defined from a step 1331 to a step 1336 of the flow chart shown in FIG. 10 with respect to the input program 90 of FIG. 6, both task tables 931 to 934 and array reference range tables 942 to 946.

FIG. 11 indicates, in detail, only fields of the task table 932 and the array reference region tables 942 and 943. Each of the task tables 931 to 934 is such a task table corresponding to each of the tasks 1 to 4 of FIG. 6. Now, while the task table 932 is employed as a task table example, the respective fields 931 to 9325 of the task table will be explained.

A pointer with respect to the next task table is stored in the field 9321 in this drawing, such an arrow directed from the field 9321 to the right direction corresponds to this pointer. When there is no next task table, a NULL value is stored. A task number is stored into the field 9322 (“2” is described in this drawing). Into the field 9323, task execution time which is estimated as to this task is stored (“6005” is described in this drawing). Into the field 9324, a total number of next-execution tasks is stored (“0” is described in this drawing). This next-execution task number is equal to a total number of tasks in which since the relevant tasks are ended, the executable conditions can be satisfied. Into the field 9325, a pointer to an array reference range table of an array which is referred to this task is stored. In this drawing, such an arrow directed from the field 9325 to the lower direction corresponds to this pointer. When there is no array reference range table as to this task, a NULL value is stored.

Next, in the array reference region tables 942 to 946, both the array reference region tables 942 and 943 store thereinto the analysis result of the task 2 of FIG. 6; both the array reference region tables 944 and 945 store thereinto the analysis result of the task 3; and the array reference region table 946 stores thereinto the analysis result of the task 4. The task 1 corresponds to such a task which is executed at first, and owns no data dependency relationship with other tasks, no that this task 1 does not own the array reference range table either.

Next, while the array reference region table 942 is employed as an example, the fields 9421 to 9423 of the array reference region table will now be explained.

Into the field 9421, an array name of such an array which is referred to this task is stored (“a” is described in this drawing). Into the field 9422, a reference region of such an array which is referred to this task is stored in such a format of “lower bound of array index: upper bound of array index” (“1:N−1” is described in this drawing). Into the field 9423, a pointer is stored, and this pointer is directed to an array reference region table for a next array which is referred to this task. In this drawing, such an arrow directed from the field 9423 to the lower direction corresponds to this pointer. When there is no array reference region table, a NULL value is stored.

Next, a description will now be made of a result obtained by applying such a process operation of the transfer information detecting unit 133 to the intermediate language 91.

At a first step 1331 of FIG. 10, the transfer information detecting unit 133 selects such an unprocessed task. As an example of this unprocessed task, the task 2 is selected. Next, at a step 1332, a judgement is made as to whether or not the executable condition of the selected task is always true. At a step 1332, the transfer information detecting unit 133 selects such a task capable of satisfying a predetermined condition. Since the executable condition of the task 2, which is analyzed in the task analyzing unit 132, is equal to “end of task 1”, this executable condition is not always true. As a result, this process operation is branched to the “NO” direction, and then is advanced to a step 1333.

Next, at the step 1333, an array reference region within a task is analyzed and the analyzed arrange reference region is recorded in the array reference region table. In other words, an array reference region of an array “a” and another array “b”, which are referred to the task 2, will be analyzed as follows: First, since a loop control variable “j” of the task 2 owns such a value of “1” to “N−1”, a reference range of an array “a” in a 9-th line whose index is equal to “j” is analyzed as “1:N−1”. Similarly, with respect to the array “b”, a reference region in an 8-th line whose index is equal to “0” is analyzed as “0”; a reference region at a left hand of 9-th line whose index is equal to “j” is analyzed as “1:N−1”, a reference region at a right hand of the 9-th line whose index is equal to “j−1” is analyzed as “0:N−2”, and a reference region at a 10-th line whose index is equal to “N−1” is analyzed as “N−1”. As a result, these reference regions are summarized, so that the reference region of the array “b” in the task 2 becomes “0:N−1”.

The above-explained analysis results are stored in the array reference region tables 942 and 943. First of all, the array name “a” is stored into the field 9421 of the array reference region table 942, the array reference region “1:N−1” is stored into the field 9422, and the array name “b” is stored into the field 9431 of the array reference region table 943, and also the array reference region “1:N−1” is stored into the field 9432, respectively. The pointer to the array reference region table 942 is stored into the field 9325 of the task table 932, the pointer to the array reference region table 943 is stored into the field 9423, and also a NULL value is stored into the field 9433 of the array reference region table 943, respectively.

Subsequently, at a step 1334, cost equal to the task execution time of the task 2 is estimated in accordance with the below-mentioned method:

First, since “N” is equal to “1000” based upon the first line of the input program 90 shown in FIG. 6, it can be seen that a loop in the seventh line of the task 2 in the input program 90 is turned 999 times.

In the eighth line of the task 2, a condition judgement of an if-clause is estimated as cost 1, and an assignment statement b[0]=0 of a resulting clause is estimated as cost 1. Since this condition judgement of the if-clause is each of loop iterations and the resulting clause is executed only when the loop control variable [j] is equal to 1, total cost of the 8-th line becomes 1000 (999+1).

In the ninth line of the task 2, both a[j] and b[j−1] of a right hand of an assignment statement are loaded and added, which are estimated as cost 1, and also b[j] of a left hand thereof is stored which is estimated as cost 1. Since this assignment statement is executed in each of the loop iteration, total cost of the ninth line becomes 3996 (999×4).

In the 10-th line of the task 2, a condition judgement of an if-clause is estimated as cost 1, and a printf-statement of a resulting clause is estimated as cost 10. Since this condition judgement is executed in each of loop iterations and the resulting clause is executed only when the loop control variable “j” is equal to 999, total cost of the 10-th line becomes 1009 (999+10).

When all of the above-described total cost are summed, the cost of this task 2 becomes 6005. This value is stored in the field 9323 of the task table 932 in FIG. 11. Similarly, cost of the task 1 is equal to 2000 (1000×2), cost of the task 3 is equal to 4996 (999×5+1), and also cost of the task 4 is equal to 3007 (999×3+10).

Next, at a step 1335, a calculation is made of a total number of tasks in which the executable condition can be satisfied when the tasks are ended, and then, this total number is recorded in the task table 93. As apparent from the table shown in FIG. 9, which indicates the executable conditions analyzed by the task analyzing unit 132 of FIG. 3, there is no such a task which owns “end of task 2” as the executable condition. As a consequence, a total number of such a task that the executable condition can be satisfied when the task 2 is ended becomes 0. This value is stored into the field 9324 of the task table 932 shown in FIG. 11.

At the next step 1336, a judgement is made as to whether or not all of the tasks contained in the program have been processed. Among the tasks 1, 3, and 4, if there is an unprocessed task by the transfer information detecting unit 133, then the process operation is branched to the NO direction, and then is returned to the step 1331. At this step 1331, the process operations defined at the steps 1332 to 1336 related to the next task are repeatedly carried out. To the contrary, when no unprocessed task is present, the process operation of the transfer information detecting unit 133 is accomplished.

The explanations as to the processing operation example of the transfer information detecting unit 133 are completed.

Next, a description will now be made of a result obtained by applying the process operation by the intermediate language transforming unit 134 of FIG. 3 to the input program 90 of FIG. 6.

The intermediate language transforming unit 134 enters thereinto the intermediate language 91, the task table 93, and the array reference region table 94 to thereby output a task scheduling processing operation, an information transfer task scheduling processing operation, and the intermediate language 91 which owns an information transfer task and is task-parallelized. It should also be noted that since the task-parallelized intermediate language 91 does not correspond to the output program 92 shown in FIG. 7 and FIG. 8, the output program 92 of FIG. 7 and FIG. 8 is employed as an expression of a source program image of the task-parallelized intermediate language 91.

First of all, the intermediate language transforming unit 134 of FIG. 3 applies the processing operation of the intermediate language parallelizing unit 1341 to the intermediate language 91. As a result, the inserted intermediate languages correspond to a 3rd line through a 6-th line, a 28-th line through a 29-th line, and an 88-th line of the output program 92 shown in FIG. 7 and FIG. 8. A third line through a sixth line correspond to a statement for defining a variable. A 28-th line corresponds to a compiler directive indicative of a commencement of a parallel execution portion; represents the commencement of the parallel execution portion by “#pragma omp parallel”; a variable myPE indicative of a processor number is designated by “PRIVATE (myPE, newMT)”; and indicates that the variable newMT becomes the separate variables in the respective processors. An 88-th line corresponds to a compiler directive representative of an end of a parallel execution portion. A 29-th line corresponds to a statement for setting the variable myPE indicative of the processor number. A right hand of this statement is equal to a processor number query function “get_processor_num”.

Next, the process operation of the task scheduling processing generation unit 1342 is applied to the intermediate language 91. As a result, the intermediate languages corresponding to the inserted task scheduling processing operation are equal to a 30-th line to a 32nd line, a 37-th line, a 40-th line to a 41st line, a 45-th line to a 46-th line, a 52nd line to a 53rd line, a 58-th to a 59-th line, a 64-th line, an 84-th line to an 85-th line, and an 87-th line of the output program 92 shown in FIG. 7 and FIG. 8. The “while” loops in the 30-th line and the 87-th line of the output program 92 correspond to such a process operation that all of the processors continuously execute the task scheduling processing operation via the “while” loops until the task 4 corresponding to the program ending task is ended. Both the 31st line and the 37-th line are directives which indicate that a section between these two statements is a critical section. A section sandwiched by these two directives represents an exclusive processing operation in which tasks can be executed only one time and only by a single processor. In the substitution statement in the 32nd line of the output program 92, a task number of such a task capable of satisfying the executable condition is derived based upon a function GET_MT_FROM_QUEUE, and the derived task number is set to a variable “newMT”. When there is no such a task capable of satisfying the executable condition, this function returns a constant variable NO_TASK. Since the content of the processing operation as to this function is not so specifically changed from the technique described in the above-explained publication 1, no detailed description thereof is made in this specification. In the output program 92, a 40-th line to a 41st line, a 45-th line to a 46-th line, a 52nd line to a 53rd line, a 58-th line to a 59-th line, a 64-th line, and an 84-th line correspond to portions for selecting such a task which is executed in accordance with the task number set to the variable “newMT” in the 32rd line of this output program 92. An 85-th line of this output program 92 corresponds to such a processing operation for setting an end flag of such a task which has been executed. The end flag corresponds to such a flag indicative of an end of a task execution. This end flag is set every task.

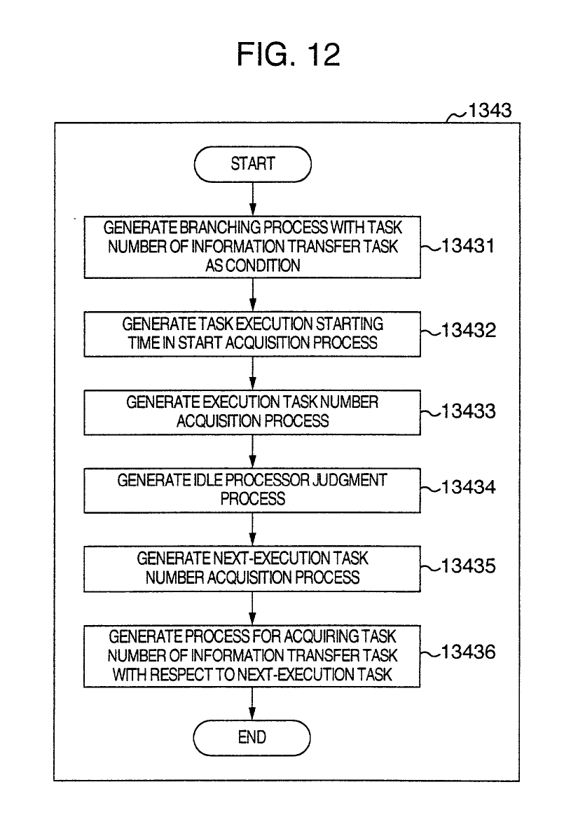

Subsequently, a description will now be made of such a case that the process operation of the task scheduling processing expansion unit 1343 is applied to the intermediate language 91. FIG. 12 is a flow chart for explaining a process sequence example of the task scheduling processing expansion unit indicated in FIG. 3. As indicated in FIG. 12, in the task scheduling processing expansion unit 1343 of FIG. 3, the respective processing operations defined from a step 13431 to a step 13436 are carried out with respective to the intermediate language.

First, at the step 13431, a branching process operation is produced in which a task number of an information transfer task is employed as a condition. As a result, the inserted intermediate languages correspond to a 65-th line to a 67-th line, a 72nd line to 73rd line, a 78-th line to a 79-th line, and an 83rd line in the output program 92 shown in FIG. 7 and FIG. 8. The intermediate languages inserted in the lines implies such a processing operation that if the task number of the information transfer task is set to the variable “newMT” then this information transfer task is executed. In this case, it is so assumed that the task number of the information transfer task is equal to such a number, namely, a total number of tasks is added to the task number of the original task with respective to the information transfer task. In the output program 92 of FIG. 7 and FIG. 8, the task numbers of 5 to 8 are applied to the informational tasks with respect to the tasks 1 to 4.

Next, at a step 13432, a task execution starting time instant acquisition process operation is generated. As result, the inserted intermediate language corresponds to a 39-th line of the output program 92 of FIG. 7 and FIG. 8, and is such a statement that the execution starting time instants of the tasks other than the information transfer task are set to a structure “TData”. A function “present_time” of a right hand of this statement corresponds to such a function capable of applying a present time instant.

Next, at a step 13433, an execution task number acquisition processing operation is generated. As a result, the inserted intermediate language corresponds to a 27-th line, a 38-th line, and an 86-th line of the output program 92 shown in FIG. 7 and FIG. 8. The 27-th line of this output program 92 is an initialized statement of an array “ExecMT”, the 38-th line thereof is such a statement that a task number of a task which is presently executed by each of processors is set to the array ExecMT, and the 86-th line thereof is such a statement that the value of the array ExecMT is returned to the initial value.

Next, at a step 13434, an idle processors judging process operation is generated. As a result, the inserted intermediate languages correspond to a 33rd line and a 36-th line of the output program 92 shown in FIG. 7 and FIG. 8. This is such a statement used to check as to whether or not the value returned by the variable “GET_MT_FROM_QUEUE” is equal to such a constant variable “NO_TASK”. This constant variable implies such a fact that there is no such a task capable of satisfying the executable condition at this time.

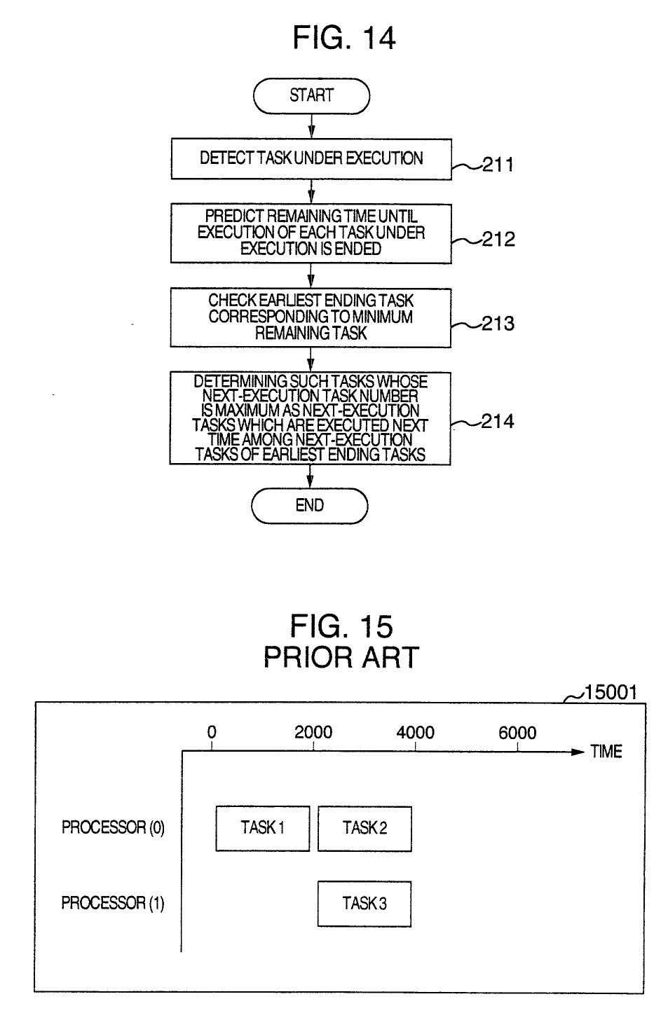

Next, at a step 13435, a next-execution task number acquisition processing operation is generated. As a result, the inserted intermediate language corresponds to statement of an 18-th to a 26-th line and of a 34-th line in the output program 92 of FIG. 7 and FIG. 8. In the 18-th line to the 25-th line, the task execution time is set to a “TaskGranularity” field of the structure “TData”, which is estimated at the step 1334 of the transfer information detecting unit 133 by employing the task tables 931 to 934 indicated in FIG. 11, and also a total number of next-execution tasks which are counted at the step 1335 of FIG. 10 is set to a “SuccTaskNo” field of the structure TData. For example, in the case of the task 2, such a value “2” stored in the field 9322 of the task table 932 shown in FIG. 11 is set to an index of the structure TData of a right hand of each of substitution statements present in the 19-th line and the 22nd line of the output program 92 shown in FIG. 7 and FIG. 8. Also, a value “6005” stored in the field 9323 is set to the right hand of the substitution statement present in the 19-th line of the output program 92. A value of “0” stored in the field 9324 is set to the right hand of the substitution statement present in the 23rd line of the output program 92. The 26-th line of the output program of FIG. 7 and FIG. 8 corresponds to an initialized statement of an ending flag of each of the tasks. Also, a 34-th line of this output program 92 corresponds to such a substitution statement that the task number of the acquired next-execution task is set to the variable “newMT”. A function “PredictSuccMT” of the right hand of this substitution statement corresponds to such a function used to acquire the number of the next execution task (namely, next-execution task number acquisition function). It should be noted that a detailed content of a processing operation of this execution task number acquisition function will be later described by employing FIG. 14.

Finally, at a step 13436, a processing operation is generated so as to acquire a task number of an information transfer task with respect to the next-execution task. As a result, the inserted intermediate language corresponds to a 35-th line of the output program 92 shown in FIG. 7 and FIG. 8. This is such a processing operation that a total number of tasks is added to the task number of the acquired next-execution task equal to the value of the variable “succMT” in order to acquire the task number of the information transfer task with respect to the next-execution task.

As previously explained, the descriptions of the processing operations of the task scheduling processing expansion unit 1343 are accomplished.

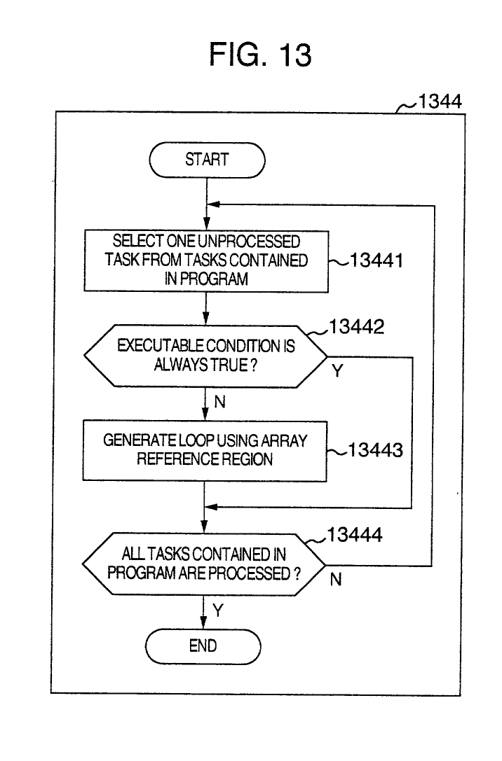

Subsequently, a description will now be made of such a case that the process operation of the information transfer task generating unit 1344 is applied to the intermediate language 91. FIG. 13 is a flow chart for explaining a process sequence example of the information transfer task generation unit indicated in FIG. 3. As indicated in FIG. 13, in the information transfer task generation unit 1344 of FIG. 3, the respective processing operations defined from a step 13441 to a step 13444 are carried out with respective to the intermediate language.

First, at the step 13441, a selection is made of one unprocessed task from the tasks contained in the program. In this example, as an example of the unprocessed task, a task 2 is selected. Next, at a step 13442 a judgment is made as to whether or not the execution condition of the selected task is always true. Since the executable condition of the task 2 analyzed by the task analyzing unit 132 of FIG. 3 corresponds to “end of task 1”, this executable condition is not always true. As a consequence, in this case, the process operation is branched to the NO direction and then is advanced to a step 1334.

Next, at a step 13443, a loop for using a reference region of an array is generated.

The intermediate languages which are inserted by utilizing the information of the array reference region tables 942 and 943 of the task 2 shown in FIG. 11 correspond to a 68-th line to a 71st line of the output program 92 shown in FIG. 7 and FIG. 8.

This is such a loop using both an element of an array “a” of a region for indexes 1 to N−1, and also an element of an array “b” of a region for indexes 0 to N−1. This loop is formed by an array name “a” which is stored in a field 9421 of the array reference region table 942, a reference region 1: N−1 stored in a field 9422 thereof, an array name “b” stored in a field 9431 of the array reference region table 943, and also a reference region 0: N−1 stored in a field 9432 thereof.

At the next step 13444, a check is made as to whether or not all of the tasks contained in the program have been processed. When there is an unprocessed task within the tasks 1, 3, and 4, the process operation is branched to the NO direction, and then the process operation is returned to the previous step 13441. Then, as to the next task, the process operations defined from the step 13442 to the step 13443 are repeatedly carried out in a similar manner. To the contrary, when there is no unprocessed task, the process operation of the step 1344 is accomplished.

As previously explained, the descriptions as to the process operation example of the information transfer generation unit 1344 shown in FIG. 3, and as to the process operation example of the intermediate transforming unit 134 shown in FIG. 3 are accomplished.

As previously explained, the intermediate language 91 which is task-parallelized by the intermediate language transforming unit 134 is entered into the optimizing unit 15, and then this optimizing unit 15 outputs the intermediate language 91. Then, the code generating unit 17 enters thereinto the intermediate language 91 optimized by the optimizing unit 15, and outputs the output program 92 shown in FIG. 7 and FIG. 8. It should also be noted that the contents of the processing operations executed in these optimizing unit 15 and code generating unit 17 are identical to those executed in the normal compiler.

The descriptions of one example of the task parallization method according to the present invention have been accomplished in the above-mentioned descriptions. Referring now to FIG. 14, a description is mode of a content of a processing operation with respect to the next-execution task number acquisition function, namely, the function “PredictSuccMT” of the right hand in the substitution statement of the 34-th line of the output program 92 shown in FIG. 7 and FIG. 8. FIG. 14 is a flow chart for describing an example of a processing operation as to the next-execution task number acquisition function. The function “PredictSuccMT” of the right hand in the substitution statement of the 34-th line of the output program 92 shown in FIG. 7 and FIG. 8 owns two sets of arguments, i.e., a first argument and a second argument. The first argument corresponds to such a structure “TData” which stores thereinto task execution time, a next-execution task number, task execution starting time, and a task ending flag of each of the tasks. The second argument corresponds to an array “ExecMT” which stores thereinto a task number presently executed by each of the processors. As shown in FIG. 14, the next-execution task number acquisition function is processed in processing steps defined from a step 211 to a step 214.

As a first step 211, a task which is presently executed is detected. This detection corresponds to such a process operation that a check is made of a value of an element where an index of the array “ExecMT” equal to the second argument of the function “PredictSuccMT” is employed as a processor number, and thus, the task number of the tasks under execution is acquired.

At the next step 212, remaining time required to accomplish the execution of each of the tasks under execution is predicted. This remaining time may be calculated by employing the structure “TData” equal to the first arrangement of the function “PredictSuccMT”. Assuming now that the task number of the task which is presently executed is equal to “I”, a prediction formula for the remaining time is given as follows:

Remaining time=estimated task execution time−(present time instant−task execution starting time instant)=Tdata[I].TaskGranularity− (present_time( )−TData[I].StartTime)

Furthermore, at the step 213, a least-remaining time task, the remaining time of which is minimum, is acquired based upon the prediction time result of the step 212.

Then, at the step 214, such a task is sought which can be executed after the execution of this least-remaining time task is completed, and the next-execution task number of this task is assumed as such a next-execution task that the most tasks correspond to next-execution tasks which will be executed in the next time. This operation corresponds to a processing operation executed in such a way that a task group in which when this least-remaining time task is accomplished, the executable condition becomes true is sought from the tasks which are not yet executed. Then, such a task is acquired from this task group, in which the value of the “SuccTaskNo” field of the “TData” structure maximum.

As previously explained, the explanations about the next-execution task number acquisition function are accomplished.

While using FIG. 1 to FIG. 14, the task parallelization method according to this embodiment has been described. That is, while monitoring as to whether or not there is such an idle processor which does not execute the task, if this idle processor is found out, then the time instants of the tasks which are being executed by other processors are predicted. Then, the next execution task corresponding to the task which is allocated to the idle processor in the next time is obtained from such a task that the predicted end time instant thereof is the earliest and time instant. Subsequently, the information transfer task is formed. This information transfer task transfers the data which may be probably referred to the next-execution task, and the instruction code contained in this task to the cache of this idle processor. Furthermore, the information transfer task scheduling process is formed. This information transfer task scheduling process is constituted by such an allocation instruction in such a manner that this formed information transfer task is executed by the idle processor. Then, this information transfer task scheduling process is added to the task scheduling process produced by the parallelizing compiler. As a result, since the data is transferred to the cache within the idle time of the processor, both the idle processor and the cache can be utilized in the more effective manner, and also, either the execution time of the program or the execution time of the object code can be shortened in such a case that a total number of the executable tasks is smaller than a total number of the usable processors at a certain time instant when the program is being executed.

It should be noted that when the data which has been previously read into the cache by the task parallelization method of this embodiment is invalidated, the shared memory is accessed as in the conventional method.

As apparent from the foregoing descriptions, the present invention is not limited to the above-described embodiments as explained with reference to FIG. 1 to FIG. 14, but may be modified, or changed withoutb departing from the technical scope and spirit of the present invention. For example, in this embodiment, both the information transfer task and the schedule process are formed. In this information transfer task, the data and the instruction code contained in this task are transferred to the cache of this idle processor. This data may be probably referred to such a task which will be allocated to this idle processor in next time. Alternatively, as the information transfer task, these data and instruction code may be transferred from the external storage apparatus to the main memory, otherwise may transferred from a remote memory of another processor to a local memory of an idle processor.

Also, the program used to execute the task parallelization method of the present invention may be stored into a computer readable storage medium, and then may be read into a memory so as to be executed.

In accordance with the present invention, even when a total number of the executable tasks is smaller than a total number of usable processors at a certain time instant while the program is executed, either the program or the object code can be outputted by which the program execution time can be shortened by effectively utilizing such an idle processor to which the task is not allocated. As a result, the performance of the multiprocessor system can be improved.

What is claimed is:

1. A task parallelization method used in a parallelizing compiler for converting a source program into one of a program and an object code, which is arranged by a plurality of tasks executable by a multiprocessor and by a task scheduling process used to allocate said plural tasks to processors, comprising the steps of:
detecting both data which may be probably referred to a relevant task capable of satisfying a predetermined condition and also an instruction code contained in said task when being compiled;
producing an information transfer task which is constructed of such an instruction for instructing that both said data and said instruction code are transferred to a storage apparatus closer to a processor to which said task is allocated; and
adding to said task scheduling process, such an information transfer task scheduling process constituted by allocation instructions by which a next-execution task is acquired and said information transfer task with respect to said next-execution task is executed by an idle processor, said next-execution task being allocated at next time to said idle processor which does not execute the task.

2. A task parallelization method as claimed in claim 1 wherein:
said next-execution task is allocated to such an idle processor that remaining time of a task presently executed is short.

3. A task parallelization method as claimed in claim 1 wherein:
as said next-execution task, a selection is made of such next-execution tasks whose number is larger than the number of said next-execution tasks.

4. A task parallelization apparatus employed in a parallelizing compiler for converting a source program into one of a program and an object code, which is arranged by a plurality of tasks executable by a multiprocessor and by a task scheduling process used to allocate said plural tasks to processors, comprising:
means for detecting both data which may be probably referred to a relevant task capable of satisfying a predetermined condition and also an instruction code contained in said task when being compiled;
means for producing an information transfer task which is constructed of such an instruction for instructing that both said data and said instruction code are transferred to a storage apparatus closer to a processor to which said task is allocated; and
means for adding to said task scheduling process, such an information transfer task scheduling process constituted by allocation instructions by which a next-execution task is acquired and said information transfer task with respect to said next-execution task is executed by an idle processor, said next-execution task being allocated at next time to said idle processor which does not execute the task.

5. A computer readable storage medium which stores thereinto a program used to execute a task parallelization method used in a parallelizing compiler for converting a source program into one of a program and an object code, which is arranged by a plurality of tasks executable by a multiprocessor and by a task scheduling process used to allocate said plural tasks to processors, comprising the steps of:
detecting both data which may be probably referred to a relevant task capable of satisfying a predetermined condition and also an instruction code contained in said task when being compiled;
producing an information transfer task which is constructed of such an instruction for instructing that both said data and said instruction code are transferred to a storage apparatus closer to a processor to which said task is allocated; and
adding to said task scheduling process, such an information transfer task scheduling process constituted by allocation instructions by which a next-execution task is acquired and said information transfer task with respect to said next-execution task is executed by an idle processor, said next-execution task being allocated at next time to said idle processor which does not execute the task.
